(19) United States
(12) Patent Application Publication
(10) Pub. No.: US 2021/0301991 A1
(43) Pub. Date: Sep. 30, 2021

(54) Lighting Arrangement For Use With Suspended Ceiling

(71) Applicant: Fusion Optix, Inc., Woburn, MA (US)

(72) Inventor: Terence Yeo, Boston, MA (US)

(73) Assignee: Fusion Optix, Inc., Woburn, MA (US)

(21) Appl. No.: 17/184,663

(22) Filed: Feb. 25, 2021

Related U.S. Application Data
(60) Provisional application No. 63/000,718, filed on Mar. 27, 2020.

(51) Int. Cl. F21S 8/06; F21V 21/088; F21V 23/04

(52) U.S. Cl. CPC F21S 8/066; F21Y 2115/10; F21V 23/0442; F21V 21/088

(57) ABSTRACT

There is disclosed a lighting arrangement for use with a suspended ceiling with a T-bar having a vertical leg and a horizontal leg. The lighting arrangement, when installed, comprises an elongate body comprising a base portion having a top plane and a bottom plane, and extending between a first end and a second end; a first clip and a second clip extending generally upwardly from the top plane at the first end and the second end respectively, defining a first channel therebetween; and a first protrusion and a second protrusion extending generally downwardly from the bottom plane at the first end and the second end respectively, defining a second channel therebetween. Herein the elongate body is adapted to be supported directly beneath the T-bar by sliding along and receiving the horizontal leg of the given T-bar in the first channel thereof, to removably mount the lighting arrangement onto the given T-bar.

### BACKGROUND

Lighting devices are utilized in many diverse applications, such as in office workspaces, in warehouses, in educational institutions, in research laboratories, in indoor and outdoor living spaces, in industrial areas, in vehicles and so forth to provide illumination for humans performing visual tasks. Contemporarily, lighting devices are also employed for aesthetic purposes to provide a visually comforting environment to a given person. Conventionally, lighting systems are affixed in ceilings, walls and other building elements to illuminate their environs.

Contemporary buildings, for example houses or offices, often employ a structural ceiling from which is supported a suspended ceiling arrangement. Typically, the suspended ceiling arrangement includes a plurality of ceiling tiles or panels hanging at a distance of approximately 30 to 50 centimeters below the structural ceiling. The suspended ceiling arrangement further includes a plurality of T-bars that are configured to support the plurality of ceiling tiles or panels in position; the plurality of T-bars is suspended from the structural ceiling, for example via an arrangement of wires. Specifically, such an arrangement of the plurality of T-bars provides cells to accommodate the plurality of ceiling tiles or panels therein. Additionally, a flush-finish of lower surfaces of the plurality of T-bars, and the plurality of ceiling tiles or panels are such that they appear as a continuous mono-planar lower ceiling surface.

Conventionally, the suspended ceiling arrangements are provided with lighting fixtures arranged to illuminate surroundings, such as, for example a, cubical space in an office, a corridor of a house, and the like. Moreover, lighting fixtures are arranged to be supported in respect of the suspended ceiling arrangements with an intention to achieve an aesthetically pleasant look. However, despite such intentions, the traditional suspended ceiling arrangements are incapable of satisfying such desirable luminaires to meet aforementioned expectations.

Major issues that are encountered with the traditional suspended ceiling arrangements are a monotonous look, complex retrofitting, costlier replacements, and the like. On many occasions, an environment or workspace is provided with multiple small lighting devices, wherein the small lighting devices include multiple light sources. However, such a configuration leads to an increase in installation and maintenance costs, inefficient energy usage, wastage of resources and environmental pollution.

A further issue that is encountered with contemporary suspending ceiling arrangements is that replacing the suspended ceiling arrangements, for example when generally refurbishing a given building in which a suspended ceiling arrangement is installed, generates a lot of waste material that is potentially not straightforward to recycle or reuse; moreover, such waste material can be environmentally disadvantageous.

Therefore, taking aforementioned problems into consideration, there exists a need to overcome the aforementioned drawbacks associated with the existing lighting devices and issues with installation of such lighting devices in a suspended ceiling grid arrangement.

### SUMMARY

The present disclosure relates to lighting arrangements for use with suspended ceiling grid arrangements.

The present disclosure seeks to provide an improved lighting arrangement for a suspended ceiling grid arrangement that is easier to manufacture, install and reconfigure or repair after initial installation (for example to achieve a modified functionality). Further, the improved lighting arrangement is inexpensive to manufacture, i.e. attributed to the simplified manufacturing and design, easier to recycle or reuse when a building incorporating the modular ceiling system is being dismantled or generally refurbished. Furthermore, the present disclosure seeks to provide an improved light arrangement for providing an improved control of light fixtures and the power supply to the light fixtures. Furthermore, the present disclosure seeks to provide an improved lighting arrangement with a modular functional fixture that is capable of accommodating various objects such as optical elements, power modules, speakers, and the like. Furthermore, the present disclosure seeks to provide an improved, robust and flexible lighting arrangement by virtue of operation to cope with varying user requirements. Moreover, the present disclosure also seeks to provide an improved energy-efficient lighting arrangement.

In one aspect, the present disclosure provides a lighting arrangement for use with a suspended ceiling, the suspended ceiling comprising one or more T-bars with each of the one or more T-bars having a vertical leg and a horizontal leg, the lighting arrangement comprising when installed:
an elongate body comprising:
   a base portion having a top plane and a bottom plane, and extending between a first end and a second end;
   a first clip extending generally upwardly from the top plane at the first end of the base portion and a second clip extending generally upwardly from the top plane at the second end of the base portion, the first clip and the second clip, along with the base portion, defining a first channel therebetween; and
   a first protrusion extending generally downwardly from the bottom plane at the first end of the base portion and a second protrusion extending generally downwardly from the bottom plane at the second end of the base portion, the first protrusion and the second protrusion, along with the base portion, defining a second channel therebetween; and
at least one elongate light assembly slidably received and disposed in the second channel of the elongate body,
wherein the elongate body is adapted to be supported directly beneath one of the T-bars by sliding along and receiving the horizontal leg of the given T-bar in the first channel thereof, to removably mount the lighting arrangement onto the given T-bar.

Optionally, the at least one elongate light assembly comprises:
a circuit board; and
one or more light emitting diodes (LEDs) arranged on the circuit board,
wherein the circuit board is slidably received and disposed in the second channel of the elongate body.

By virtue of the second channel accommodating the at least one light assembly comprising the circuit board and one or more LEDs in a simplified and compact manner consequently reducing the required installation effort and complexity for the lighting arrangement.

Optionally, the at least one elongate light assembly comprises a first elongate light assembly and a second elongate light assembly, wherein the first elongate light assembly and the second elongate light assembly are of mutually different configurations.

The first elongate light assembly and the second elongate light assembly provide an improved utility to the lighting arrangement by providing different aesthetic lighting features corresponding to their mutually different configurations.

Optionally, the elongate body has one or more extrusions formed therein, wherein the one or more extrusions have one or more power supply lines routed therethrough to connect electrically the first elongate light assembly and the second elongate light assembly in a daisy-chain manner.

The one or more extrusions formed in the elongate body enables concealing the electrical connections and wiring of the lighting arrangement, whereas the daisy-chain manner of the light assembly provides a simplified and compact arrangement and at the same time allows for an improved scalability of the lighting arrangement.

Optionally, the elongate body is formed by extrusion molding of one or more of polypropylene, nylon, polyethylene and aluminum.

The elongate body being formed via extrusion molding reduces the manufacturing effort and complexity and allows a simplified design i.e. easier and cheaper to manufacture. Moreover, by virtue of selecting a polymer material for forming the elongate body to provide an elongate body having improved flexibility, whereas by virtue of selecting a metal for the elongate body to provide a highly rigid or robust body.

Optionally, the first clip and the second clip are fabricated as a rigid construction.

The rigid fabrication of the first and second clip provides a robust lighting arrangement and aids to easily conform or accommodate the T-bar in the vacant space to enable an easier installation requiring a minimal effort or level of expertise.

Optionally, the first clip and the second clip are fabricated as a semi-rigid construction, such that the first clip and the second clip are adapted to be flexed (for example, using manual finger force of up to 30 Newtons) to, respectively, mount onto opposing ends of the horizontal leg of the given T-bar.

The semi-rigid fabrication of the first and second clip provides a flexible lighting arrangement and allows a varying tolerance and hence providing a degree of freedom during installation.

Optionally, the first clip and the second clip are formed of a substantially magnetic material, such that the first clip and the second clip are adapted to be, respectively, slidably received and thereafter firmly held with opposing ends of the horizontal leg of the given T-bar at a desired position.

The formation of the first and second clip using a substantially magnetic material allows for a closer contact and eliminating vacant spaces between the adjacent elements to provide a tight-fitted, aesthetically pleasant lighting arrangement and also inhibiting dust formation therebetween.

Optionally, the lighting arrangement further comprises two walls extending downwardly from the first end and the second end of the base portion, respectively and have inwardly projecting lips to define a third channel therebetween.

Optionally, at least one elongate optical element supported in the third channel such that the at least one elongate optical element is located directly beneath the at least one elongate light assembly.

The selection and arrangement of the at least one elongate optical element with respect to the at least one elongate light assembly allows a provision of support for the optical elements and different aesthetic features to be implemented as per requirement.

Optionally, the lighting arrangement further comprises a sensor arrangement configured to switch the lighting arrangement based on at least a user requirement or a user activity.

The sensor arrangement enables the lighting arrangement to reduce power consumption during times of minimal or no activity and consequently conserving energy to provide a green or eco-friendly lighting arrangement.

Optionally, the sensor arrangement further comprises at least one of an audio sensor, acoustic sensor, motion sensor, position sensor, proximity sensor, light sensor, ultrasonic sensor and accelerometer.

Embodiments of the present disclosure substantially eliminate, or at least partially address, the aforementioned problems in the prior art, and provide an improved lighting arrangement to provide more uniform light distribution patterns that mitigate visual discomfort and are aesthetically appealing to a given viewer.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 is a perspective top view illustration of a lighting arrangement supported on a T-bar, in accordance with an embodiment of the present disclosure;

FIG. 2 is a perspective view illustration of a T-bar, in accordance with another embodiment of the present disclosure;

FIG. 3 is a perspective top view illustration of the lighting arrangement, in accordance with an embodiment of the present disclosure;

FIG. 4 is a perspective top view illustration of an elongate body of the lighting arrangement, in accordance with an embodiment of the present disclosure;

FIG. 5 is a perspective top view illustration of the lighting arrangement with an optical element arranged therewith, in accordance with an embodiment of the present disclosure;

FIG. 6 is a front view illustration of a lighting arrangement, in accordance with an embodiment of the present disclosure;

FIG. 7A is a perspective view illustration of a lighting arrangement, in accordance with an embodiment of the present disclosure;

FIG. 7B is a perspective view illustration of a lighting arrangement, in accordance with another embodiment of the present disclosure;

FIGS. 8 to 12 are schematic view illustrations of the lighting arrangements, in accordance with various other embodiments of the present disclosure;

FIGS. 13A to E are front views illustrations of lighting arrangements with different T-bars, in accordance with various embodiments of the present disclosure; and

FIGS. 14A to E are front views illustrations of lighting arrangements in a utilized state, in accordance with various embodiments of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

In overview, embodiments of the present disclosure are concerned with a lighting arrangement for providing various light distribution patterns in an environment. Furthermore, the embodiments of the present disclosure also provide a lighting arrangement which is supported directly beneath a T-bar by sliding along and receiving the horizontal leg of the given T-bar to provide an aesthetically appealing appearance to the T-bar and its associated lighting arrangement.

Modular ceiling systems are employable to implement suspended ceilings, also referred to herein as “suspended ceiling grid arrangements”. Herein, the term “suspended ceiling grid arrangements” refers to a ceiling including a ceiling grid suspended or hung at a height below a structural ceiling of a given architecture, such as a room of a house, or a building. It will be appreciated that the structural ceiling is an overhead interior surface that covers, namely defines, an upper spatial limit of a room. In an example, the structural ceiling may be at a height of 2.5 meters from a floor (not shown) of the room. In such an example, the height below the structural ceiling for holding the suspended ceiling grid arrangement is 0.25 (approximately) metres (meters) from the height of the structural ceiling, i.e. 2.25 (approximately) metres (meters) from a floor of the room. Furthermore, the suspended ceiling grid arrangement is suspended or hung at the height using the hanging wires that are securely fixed to the structural ceiling. Optionally, the hanging wires can be hinged, hooked, tied, coupled, plastered securely or fixed to the structural ceiling. In an instance, during installation, the hanging wires are coupled to the structural ceiling to support the suspended ceiling grid arrangement to be hung at the height therefrom.

Furthermore, the suspended ceiling grid arrangement is supported by the hanging wires at the height to provide a gap between the structural ceiling and the suspended ceiling grid arrangement. Beneficially, the gap provides a space for the electrically and/or electronically operated ceiling device to be arranged therebetween.

Typically, the suspended ceiling grid arrangement includes a grid formation constructed using metallic bars (T-bars). The term “T-bars” used herein relates to hardware components such as an elongate rigid spine extending between terminal ends of the ceiling. Additionally, the T-bars include an inverted T-shaped structure comprising a flat vertical leg (supporting portion) integral to a flat horizontal leg (base portion). Furthermore, the T-bars include either a fixed anchor or an adjustable anchor for attachment to an adjacent member, such as another T-bar(s) or other holding arrangement(s) for securely holding or suspending the T-bar. The T-bars are of various styles, types and sizes and are generally characterized by the grid type. The term “grid type” refers to the a property of the T-bar indicating the type, style or size of the T-bar being implemented. Generally, the grid type of the T-bar is a 15/16″ flat style. However, other different grid types or other styles may also be implemented without limiting the scope of the disclosure. For instance, other grid type includes, but is not limited to, a slimline grid type or 9/16″ flats including a 9/16″ slot, a concealed grid type or a semi-concealed grid type. Moreover, larger T-Bars including 1.5″ and 2″ grid type are employed in industrial applications such as clean rooms, data centers, food processing plants and so forth. Optionally, the T-bars are conjoined to the hanging wires, either by hooking, welding, gluing, and so forth. Moreover, the T-bars include tracks or holes to which the hanging wires can be coupled to and/or can be latched onto for supporting (i.e. holding or suspending) the suspended ceiling grid arrangement from the structural ceiling. Furthermore, the T-bars of the suspended ceiling grid arrangement form an array of cells into which ceiling panels can be arranged. Moreover, the array of cells is formed by the grid of horizontal legs of the T-bars. Optionally, the T-bars also include axes (imaginary line) passing through joining of the vertical legs and the horizontal legs. Furthermore, the axes cross each other when two T-bars overlap or cross each other either perpendicularly or at an angle.

Furthermore, the term “ceiling panels” as used herein relates to a lightweight structure, usually a shallow “cuboidal” structure, having a length, a breadth, and a height which are placed within the opening formed by the T-bars for providing a planar lower surface of the suspended ceiling. Optionally, the ceiling panels are fabricated from a porous cellular structure, having gaseous voids therein. Optionally, the ceiling panels are implemented as a plurality of substantially mutually identical panels, wherein each panel has major exterior surfaces that are substantially rectangular in form, for example square in form, when viewed from the given room. The ceiling panels have edges that rest on the lower planar portions of the T-bars. Optionally, the ceiling panels include at least one edge having one or more lengthwise protruding lips and/or one or more lengthwise grooves along a whole length of the edge, thereby enabling the ceiling panels to be securely held (namely supported) on the grid formed by the lower planar horizontal legs of the T-bars.

Furthermore, the grid formation is configured to accommodate various electronic and/or electrical devices for providing a plurality of services in the room. Examples of various electronic and electrical devices may include at least one of: lights, alarms, sensors, ventilation fans, heaters, humidifiers and the like. Optionally, the suspended ceiling grid arrangement can include a power system for supplying electric power to the various electrically and/or electronically operated ceiling devices.

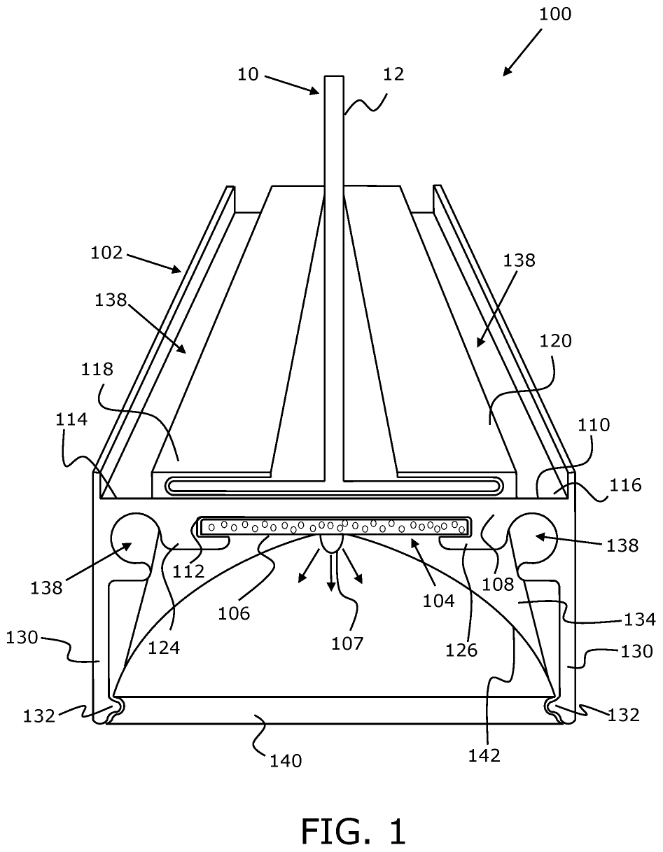

Referring to FIG. 1, there is shown a perspective top view illustration of a lighting arrangement (generally indicated by reference numeral 100) supported on a T-bar (generally indicated by reference numeral 10), in accordance with an embodiment of the present disclosure. Herein, the T-bar 10 is optionally a part of a suspended ceiling grid arrangement (not shown). In drop ceiling environments such as office space and residential homes, the T-bar 10 acts as a support grid that holds ceiling tiles in place in order to form a drop ceiling. To form the grid, typically T-bars 10 running in a first direction are long T-bars, long enough to span an entire room (or as far as possible in a larger room where it is impractical to have T-bars spanning the entire length of the room). In a second direction perpendicular to the first direction, shorter T-bars are located which merely extend between adjacent long T-bars. In addition to supporting ceiling tiles, the T-bars 10 are also capable of supporting air conditioning returns and registers, as well as light fixtures and other equipment.

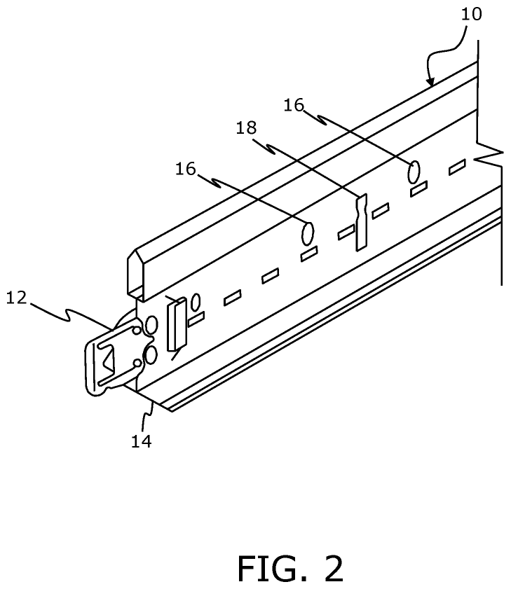

As shown in FIG. 1, the T-bar 10 includes a vertical leg 12 and a horizontal leg 14. In the suspended ceiling grid arrangement, typically, the upper vertical leg 12 of each T-bar 10 has holes (shown later in FIG. 2) periodically passing therethrough through which wire or other suspension elements can connect to support the suspended ceiling array of T-bars at the desired elevation above the floor. Furthermore, the horizontal legs 14 of the T-bars 10 define a general ceiling plane for supporting the plurality of ceiling panels. The term “general ceiling plane” used herein relates to an imaginary plane parallel to the structural ceiling, formed by lower horizontal legs 14 of the T-bars 10. Herein, the axes of the horizontal legs 14 of the T-bars 10 are coplanar to the general ceiling plane. Additionally, the general ceiling plane is parallel to floor of, for example, room of a house. Optionally, the general ceiling plane is at a height 2.5 to 3 metres above the floor of the house.

FIG. 2 is a perspective top view of a T-bar 10, in accordance with an embodiment of the present disclosure. As illustrated, the T-bar 10 includes the vertical leg 12 and the horizontal leg 14. In the suspended ceiling grid arrangement, the vertical leg 12 of each T-bar 10 has one or more holes 16 periodically passing therethrough through which a wire or any other suspension element may connect with and support the suspended ceiling array of T-bars at the desired elevation above the floor. Further, the T-bar 10 includes one or more slots 18 configured to accommodate the anchor of the T-bar 10. Furthermore, the horizontal legs 14 of the T-bars 10 define the general ceiling plane for supporting the plurality of ceiling panels. The general ceiling plane is formed by the lower horizontal legs 14 of the T-bar 10. Herein, the axes of the horizontal legs 14 of the T-bars 10 are coplanar to the general ceiling plane. Additionally, the general ceiling plane is parallel to floor of, for example, room of a house, clean room etc. Optionally, the general ceiling plane is at a height 2.5 to 3 metres above the floor of the house. Typically, the vertical portion 12 comprises the T-bar anchor configured to be mechanically coupled with other mechanical components, the wall or ceiling to support the lighting arrangement 100.

According to an embodiment of the present disclosure, the lighting arrangement 100 of the present disclosure may be used in conjunction with a support element (not shown), other than the T-bar, which forms a part of the suspended ceiling grid arrangement. In an example, the support element can be an elongate extruded body, which can be coupled to the ceiling with the help of wires or any other suspension element. Otherwise, the support element may be mounted on existing T-bars for providing more modular approach to the of the suspended ceiling grid arrangement. In an example, the support element may be configured to support ceiling tiles thereon. Additionally, the support element may also provide other functionality, for example, for supporting functional elements, such as lights, sensors, electrical circuits, electrical cables and so forth.

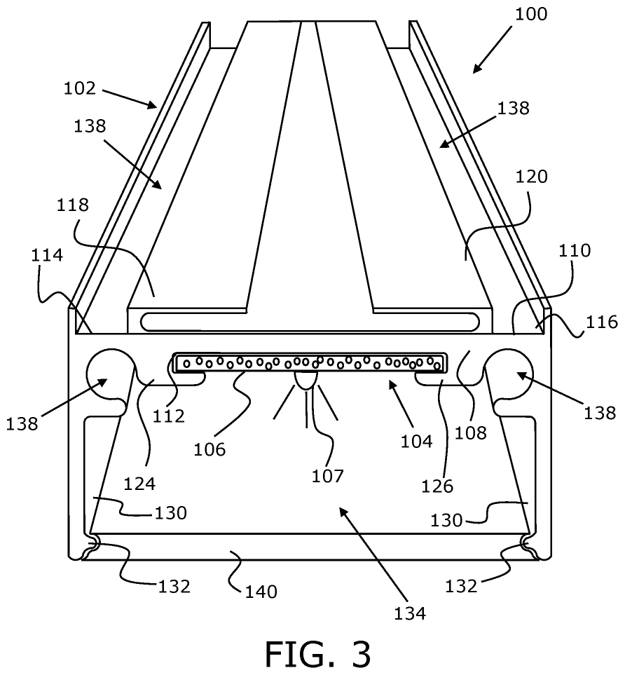

FIG. 3 is a perspective top view illustration of the lighting arrangement 100 (separated from the T-bar 10), in accordance with an embodiment of the present disclosure. As illustrated, the lighting arrangement 100 includes an elongate body 102 and at least one elongate light assembly 104. Herein, the elongate light assembly 104 includes a printed circuit board 106 and one or more light emitting diodes (LEDs) 107 (only one being shown in the illustration) arranged on the printed circuit board 106. Typically, the LEDs 107 are arranged on the printed circuit board 106 in a predefined pattern to provide a desired pattern of illumination. As well be appreciated from FIG. 3, the elongate light assembly 104 is arranged and supported in the elongated body 102, in the lighting arrangement 100. In particular, the printed circuit board 106 of the elongate light assembly 104 is received and accommodated in the elongated body 102 (details discussed in the preceding paragraphs), to support the elongate light assembly 104 with the elongated body 102 in the lighting arrangement 100. It will also be appreciated that although the elongate light assembly 104 has been shown and described to include the printed circuit board 106 with the plurality of light emitting diodes 107 arranged thereon, the elongate light assembly 104 optionally has any other suitable configuration without departing from the scope and the spirit of the present disclosure.

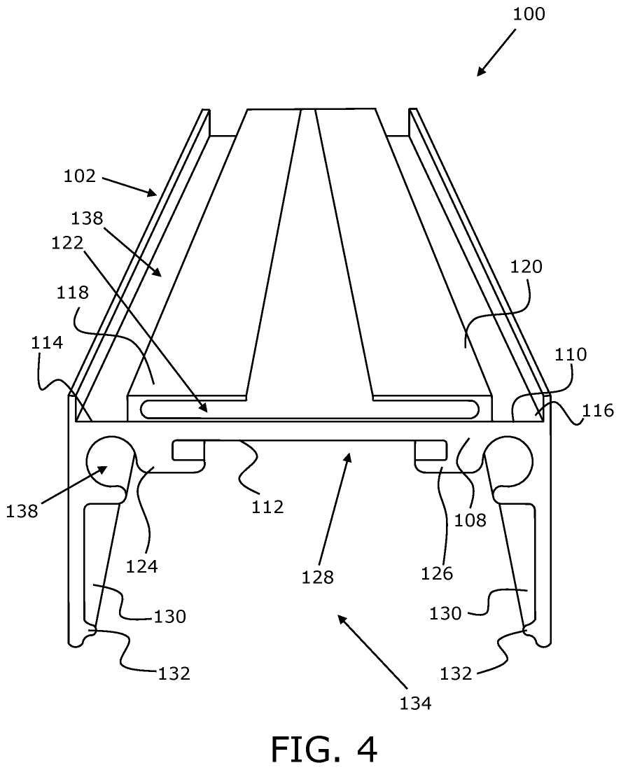

FIG. 4 is a perspective top view illustration of the elongate body 102, without the elongate light assembly 104, of the lighting arrangement 100, in accordance with an embodiment of the present disclosure. As illustrated, the elongate body 102 is an extruded profile. In an embodiment, the elongate body 102 is formed by extrusion molding of plastics materials or metallic materials. For example, the elongate body 102 is formed by extrusion molding of plastics material, such as one or more of polypropylene, nylon, polyethylene and the like. In another example, the elongate body 102 is formed by extrusion molding of metallic material, such as, but not limited to, aluminum (US English: aluminum). In other examples, the elongated body is manufactured using manufacturing techniques such as film casting, sheet casting, profile extrusion, blown film extrusion, injection moulding, etc. in accordance with embodiments of this invention.

As illustrated in FIG. 4, the elongate body 102 includes a base portion 108. The base portion 108 is fabricated in a shape of a flat shaped member having a top plane 110 and a bottom plane 112. It will be seen that the top plane 110 and the bottom plane 112 form two opposing sides of the base portion 108. The base portion 108 extends, generally, between a first end 114 and a second end 116 of the elongate body 102. Herein, the first end 114 and the second end 116 are lateral ends of the elongate body 102 and define a width of the elongate body 102 in the lighting arrangement 100.

Furthermore, as illustrated, the elongate body 102 includes a first clip 118 extending generally upwardly from the top plane 110 of the base portion 108. The first clip 118 is generally extending from the first end 114 of the base portion 108. Moreover, the elongate body 102 includes a second clip 120 extending generally upwardly from the top plane 110 of the base portion 108. The second clip 120 is generally extending from the second end 116 of the base portion 108. As will be seen, the first clip 118 and the second clip 120, along with the base portion 108, define a first channel 122 therebetween. The first channel 122 is in a form of a hollow space, above the base portion 108, adapted to receive the horizontal leg 14 of the T-bar 10. It will be appreciated that a width of the base portion 108 is beneficially defined as such to allow for accommodation of the horizontal leg 14 of the T-bar 10 in the first channel 122.

Referring back to FIG. 1, as will be seen, herein, the elongate body 102 is adapted to be supported directly beneath the T-bar 10 by sliding along and receiving the horizontal leg 14 thereof in the first channel 122, to removably mount the lighting arrangement 100 onto the T-bar 10. It will be appreciated that with such an arrangement, ledges provided by the clips 118, 120 on both sides of the lighting arrangement 100 provide a resting place for ceiling tile in the suspended ceiling grid arrangement.

Furthermore, as illustrated in FIG. 4, the elongate body 102 includes a first protrusion 124 extending generally downwardly from the bottom plane 112 of the base portion 108. The first protrusion 124 is generally extending from the first end 114 of the base portion 108. Moreover, the elongate body 102 includes a second protrusion 126 extending generally downwardly from the bottom plane 112 of the elongate body 102. The second protrusion 126 is generally extending from the second end 116 of the base portion 108. As will be seen, the first protrusion 124 and the second protrusion 126, along with the base portion 108, define a second channel 128 therebetween. The second channel 128 is in a form of a hollow space, below the base portion 108, adapted to receive the at least one elongate light assembly 104 in the lighting arrangement 100. In particular, the second channel 128 is beneficially defined to allow for accommodation of the circuit board 106 of the elongate light assembly 104 in the lighting arrangement 100. Herein, the elongate light assembly 104 is slidably received and disposed in the second channel 128 of the elongate body 102.

Furthermore, as illustrated in FIG. 1, the elongate body 102 includes two walls 130 extending downwardly from the first end 114 and the second end 116 of the base portion 108, respectively. Furthermore, the walls 130 have inwardly projecting lips 132, which along with the walls 130 define a third channel 134 therebetween. It will be seen that the third channel 134 is located directly beneath the second channel 128. Furthermore, the elongate body 102 includes an optical element 140. Typically, the optical element 140 is a light directing lens configured to distort incoming light. The optical element 140 works on the principle of refraction to distort beams of light as they travel through the optical element 140 based on the implementation. The optical element 140 is formed as a part of the elongate body 102 and joined at both ends via the inwardly projecting lips 132. Moreover, the optical element 140 may be employed with other system components such as a reflector 142. Alternatively, the optical element 140 may be employed without a reflector as shown in FIG. 3.

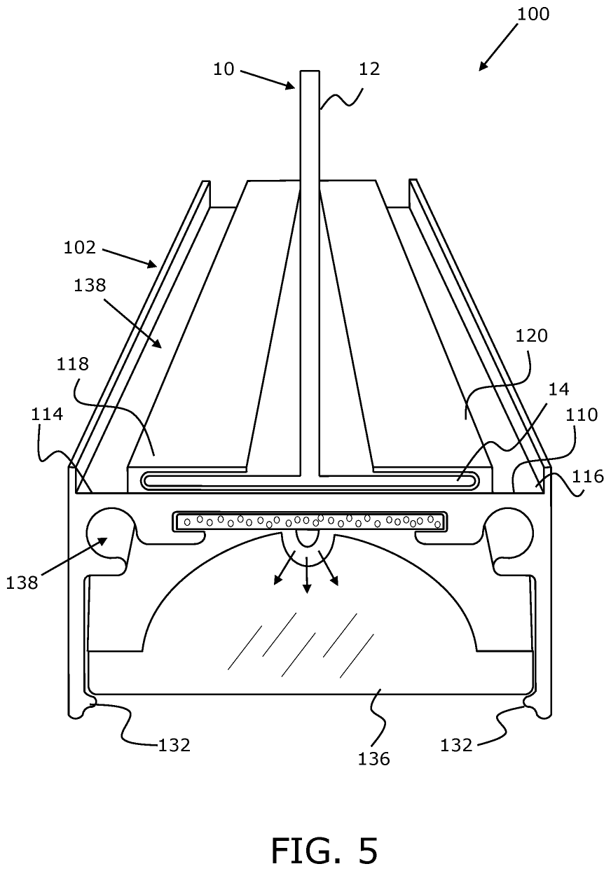

Referring to FIG. 5, there is shown a perspective front view illustration of the lighting arrangement 100 (separated from the T-bar 10), in accordance with another embodiment of the present disclosure. As illustrated, the lighting arrangement 100 includes at least one elongate optical element 136 supported in the third channel 134. In the present examples, the elongate optical element 136 is beneficially a total internal reflection (TIR) lens. The design of the elongate optical element 136 or the TIR lens relies on the principal of total internal reflection. Generally, the TIR lens includes a rotationally symmetrical design to provide a uniform light distribution. However, the design of the elongate optical element 136 may be varied as per the implementation. Moreover, the elongate optical element 136 may be designed in the form of arrays for including multiple LEDs or other mechanical components to further aid the mounting or support of the lighting arrangement 100.

It will be appreciated from the illustration of FIG. 4 that the first channel 122 in the elongate body 102 conforms to the shape of the horizontal leg 14 of the T-bar 10 (as shown in FIG. 1) to create a conformal flush fit therewith when the lighting arrangement 100 is mounted thereon. Furthermore, the second channel 128 in the elongate body 102 provides a space to accommodate the elongate light assembly 104, for assembly of the lighting arrangement 100. Moreover, as illustrated in FIG. 5, with the third channel 134 located beneath the second channel 128, the at least one elongate optical element 136 is located directly beneath the at least one elongate light assembly 104, in the lighting arrangement 100. In the present embodiments, the elongate optical element 136 is optionally non-integral to the elongate light assembly 104; alternatively, optionally, the elongate optical element 136 is optionally integral to the elongate light assembly 104. It will be appreciated that the elongate optical element 136 is beneficially shaped such that the integrated elongate light assembly 104 slides into the second channel 128, with the printed circuit board 106 disposed in the second channel 128 and the elongate optical element 136 disposed in the third channel 134.

In one embodiment, the first clip 118 and the second clip 120 are of rigid construction. In such a configuration, the first channel 122 formed thereby has a rigid shape, such that the elongate body 102 is supported by sliding along and receiving the horizontal leg 14 of the T-bar 10 in the first channel 122, to mount removably the lighting arrangement 100 onto the T-bar 10 (as shown in FIG. 1). That is, a user is able simply to slide the lighting arrangement 10 onto the T-bar 10 for installation thereof. In another embodiment, the first clip 118 and the second clip 120 are of a semi-rigid construction. In such a configuration, the first clip 118 and the second clip 120 are adapted to be flexed to, respectively, mount onto opposing ends of the horizontal leg 14 of the T-bar 10; such flexing is beneficially achieved using finger force, for example using a force of not more than 30 Newtons. That is, a user is able flex the clips 118 and 120 to mount the lighting arrangement 10 onto the T-bar 10 for installation thereof. Specifically, the user is able to squeeze the first clip 118 and the second clip 120 together or individually from sides at a lower portion of the extruded profile to cause an upper portion of the extruded profile to flex outwards, allowing clip-mounting onto the T-bar 10. In yet another embodiment, the first clip 118 and the second clip 120 are formed of a substantially magnetic material. In such a configuration, the elongate body 102 is supported by sliding along and receiving the horizontal leg 14 of the T-bar 10 in the first channel 122. Specifically, the first clip 118 and the second clip 120 are adapted to be, respectively, slidably received and thereafter firmly held in place by magnetic attraction with opposing ends of the horizontal leg 14 of the T-bar 10 at desired position. In all of the above described configurations, the lighting arrangement 100 is supported directly beneath the T-bar 10 to provide the appealing aesthetic appearance.

Furthermore, as shown in FIGS. 1 to 5, the elongate body 102 has one or more extrusions 138 formed therein. In some examples, the one or more extrusions 138 are utilized to have one or more power supply lines (not shown) routed therethrough to connect electrically the elongate light assembly 104 with a main power supply. In other examples, the one or more extrusions 138 are utilized to accommodate other components, such as a LED driver (not shown) or the like, required for functioning of the elongate light assembly 104, or in general for functioning of the overall lighting arrangement 100, without any limitations.

In the illustrated embodiments, the elongate light assembly 104 has been shown to have a direct lit lighting configuration which provides a light distribution with peak intensity normal thereto. In other embodiments, the elongate light assembly 104 optionally has an edge lit lighting configuration in which light from the LEDs 107 arranged on the printed circuit board 106 is input into the edge of the elongate optical element 136 and the output face of the elongate optical element 136 becomes the light emitting surface of the lighting arrangement 100. In some examples, the surface of the circuit board 106 optionally has an optically reflective surface such as a white paint to enhance optical efficiency of the elongate lighting assembly 104. It will be understood that the LEDs 107 populate the printed circuit board 106 from which light is emitted and dispersed into the elongate optical element 136 before exiting the lighting arrangement 100.

In the present lighting arrangement 100, the elongate optical element 136 optionally scatters the light from the elongate light assembly 104. In addition to scattering light, the elongate optical element 136 is optionally used with the elongate light assembly 104 to reduce glare, as it beneficially has light directing surface features. Examples of the elongate optical element 136 include, but are not limited to, geometric shapes such as half spheres, pyramids, truncated pyramids, lenticulars, and linear prisms. In one or more embodiments, the elongate optical element 136 can be combined with other elements or contain features that improve the optical performance in terms of diffuse or specular transmission or reflection, gain, haze, clarity, backscatter, angular modification of the exiting light profile (reflecting or transmitting) in one or more directions, angular modification of the exiting (reflecting or transmitting) profile for at least one polarization state in one or more directions, percent of polarization preserved, and spectral transmission or absorption properties.

Moreover, alternative lighting arrangements employing either a narrow beam or a wide beam operation depending upon the user requirement. The term “narrow beam” or “wide beam” refers to a range of angle dispersion or spread for the transmitted light from the lighting arrangement. Generally, the narrow beam of light includes the angles of dispersion between 10 to 100 degrees, whereas the wide beam of light includes the angles of dispersion between 120 to 180 degrees.

Optionally, the lighting arrangement as described in the present disclosure comprises one or more LEDs to provide both a narrow beam operation and a broad beam operation and wherein the lighting arrangement is configured to switch therebetween as an option (for example via remote control). For example, a wide beam illumination with a relatively low power consumption is beneficial in areas where a user is not working or a low level of illumination is required, and a narrow beam illumination is beneficial in regions where user is working or require a high level of illumination.

In an embodiment, the lighting arrangement 100 further comprises a sensor arrangement configured to switch the lighting arrangement 100 based on at least a user requirement or a user activity. The term “user activity” refers to a movement or action detected by at least one of the sensors in the sensor arrangement, based on which the lighting arrangement 100 is configured to operate corresponding to the user activity. In an implementation scenario, the lighting arrangement 100 comprising the sensor arrangement may include an Internet-of-Things (IOT) device configured for switching the lighting arrangement “ON” or “OFF”. Moreover, the lighting arrangement may be configured to detect a presence or movement of a user for switching the lighting arrangement “ON” or “OFF”. In an example, user activity may include, a a hand clap, hand movement, finger pinch or flick and the like.

In another embodiment, the sensor arrangement further comprises at least one of an audio sensor, acoustic sensor, motion sensor, position sensor, proximity sensor, light sensor, ultrasonic sensor and accelerometer. In an example, the lighting arrangement 100 comprising the sensor arrangement is equipped with a sound recognition sensor (e.g. an ultrasound sensor) configured to control the lighting arrangement 100 via another device, such as an ultrasonic hand controller, a near-field wireless device or even ordinary acoustic signals such as human clapping of hands.

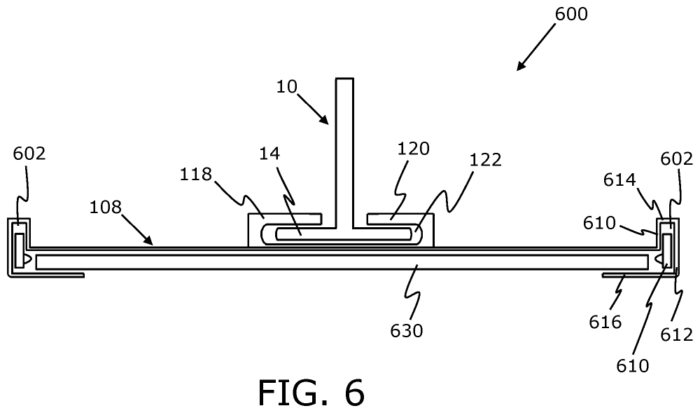

Referring now to FIG. 6, illustrated is a front view illustration of a lighting arrangement 600, in accordance with an embodiment of the present disclosure. As shown, the lighting arrangement 600 includes a base portion, such as the base portion 108, with first and second clips, such as the first and second clips 118, 120, arranged on a top surface of the base portion 108. The first and second clips 118, 120 defines a first channel, such as the first channel 122, for receiving horizontal leg 14 of the T-bar 10. As shown, the base portion 108 is a flat structure with channels, such as the second channels 602, configured at lateral edges of the base portion 108. The second channels 602 are configured by pair of spaced apart vertical and horizontal members, such as vertical members 610, 612 and horizontal members 614, 616. The second channels 602 are configured to receive or support elongate light assemblies 620. As shown, the elongate light assemblies 620, are smaller and thinner as compared the elongate light assemblies 104 of FIG. 1, conforming to the second channels 602. The lighting arrangement 600 also includes an optical element 630 located directly beneath the base portion 108 and adjacent to the elongate light assemblies 104. As shown, the optical element 630 is supported by the horizontal members 616.

According to embodiments of the present disclosure, the lighting arrangement is configured to allow sliding of interchangeable sections to create different looks and different lighting distributions.

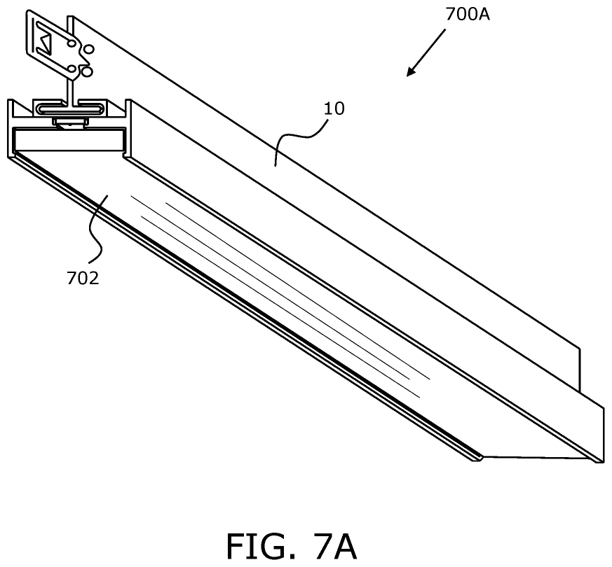

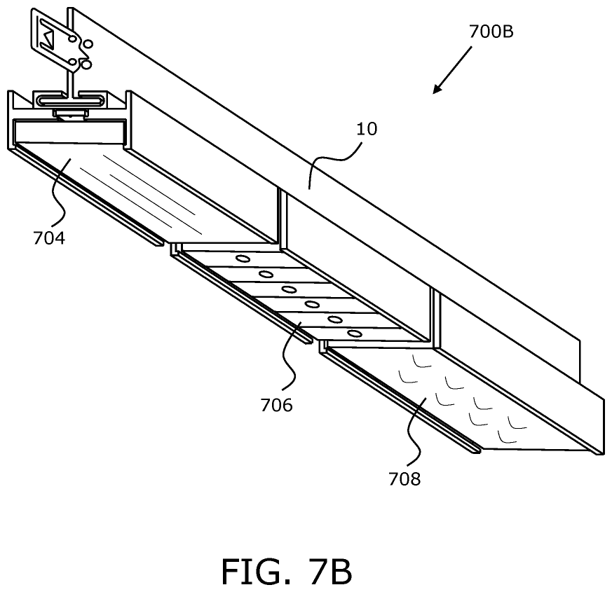

Referring to FIG. 7A, illustrated is a perspective view of a lighting arrangement 700A supported on the T-bar 10, in accordance with an embodiment of the present disclosure. As illustrated, the lighting arrangement 700A includes a single elongate light assembly 702, wherein the single elongate light assembly is supported directly beneath the same T-bar 10. It will be understood that the single elongate light assembly 702 is slidably-mounted onto the T-bar 10 as discussed with reference to FIGS. 1 to 5. In the present configuration, the single light assembly 702 may comprise any shape, size, color, design or specification and so forth, without limiting the scope of the disclosure. For example, in the illustrated example, the single elongate light assembly 702 is a linear diffusing light. In another example, the single elongate light assembly 702 is a collection of small spot-lights. In yet another example, the single elongate light assembly 702 is a scattering light. Typically, the single elongate light assembly 702 comprises one or more LEDs connected with a PCB arrangement to generate the lighting. Specifically, by varying the number, size, color, resistance or power of the one or more LEDs and corresponding PCB arrangement different types of lighting distributions using the single elongate light assembly 702 are achieved.

According to an embodiment of the present disclosure, the lighting arrangement of the present disclosure, with its simple design and configuration, allows mounting and interchanging of mutually different (or even same) types of light assemblies directly beneath the same T-bar 10. It will be appreciated that the lighting arrangement of the present disclosure can be retro-fittingly slidably-mounted onto existing T-bars 10. Further it will be appreciated by a person skilled in the art that with the present design, multiple light arrangements (with same or varying light assemblies) can be slide-mounted directly beneath the same T-bar 10 along the length thereof.

Referring to FIG. 7B, illustrated is a perspective view of a lighting arrangement 700B supported on a T-bar 10, in accordance with another embodiment of the present disclosure. As illustrated, the lighting arrangement includes multiple elongate light assemblies, including a first elongate light assembly 704, a second elongate light assembly 706 and a third elongate light assembly 708 supported directly beneath the same T-bar 10. It will be understood that each of the multiple elongate light assemblies 704, 706, 708 are slidably-mounted onto the T-bar 10 as discussed with reference to FIGS. 1 to 5. In the present configuration, each of the first elongate light assembly 704, the second elongate light assembly 706 and the third elongate light assembly 708 are of mutually different configurations. Herein, the different light assemblies are of mutually different shape, size, color, design, specification, etc. without any limitations. For example, in the illustrated example, the first elongate light assembly 704 is a linear diffusing light, the second elongate light assembly 706 is a collection of small spot-lights and the third elongate light assembly 708 is a scattering light. In the present example, the one or more extrusions (such as, the extrusion 138) have one or more power supply lines routed therethrough to connect electrically the first elongate light assembly 704, the second elongate light assembly 706 and the third elongate light assembly 708 in a daisy-chain manner. The first elongate light assembly 704, the second elongate light assembly 706 and the third elongate light assembly 708 arranged in a daisy-chain manner allows a simplified electrical connection for the series of LED's in each of the elongated light assemblies and correspondingly an easier installation. Moreover, the daisy chain structure of the elongate light assemblies apart from providing a simplified electrical connection, also provides an improved communication capability therebetween.

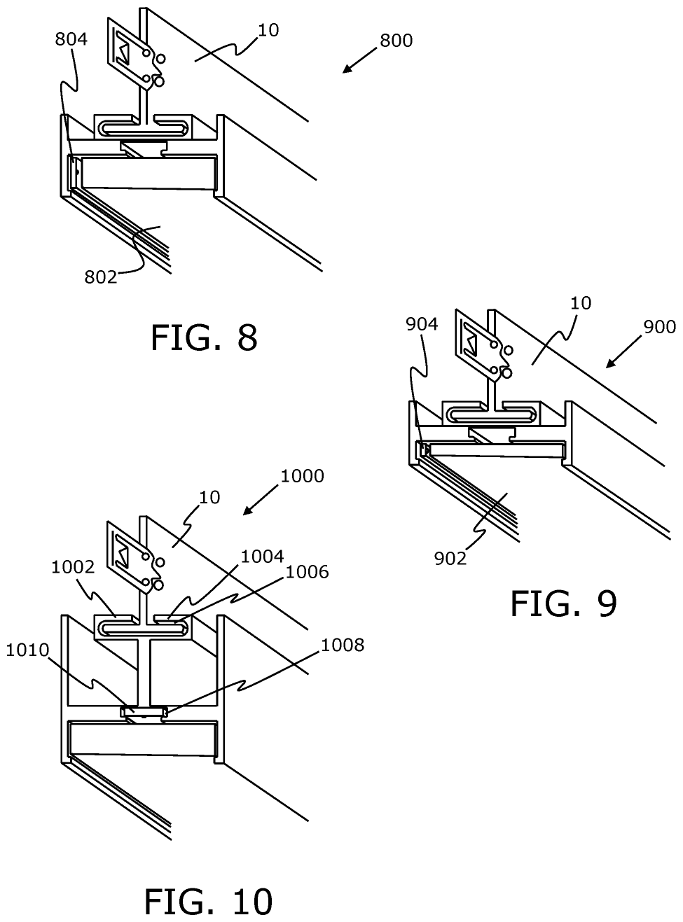

FIGS. 8 to 12 are schematic illustrations of different types of lighting arrangements supported on respective T-bars 10, in accordance with various embodiments of the present disclosure. As shown in FIGS. 8-12, illustrated are different types of light arrangements (similar to the lighting arrangement 100 of FIG. 1-5) having different sizes and positions of various parts of the lighting arrangements, such as, but not limited to, channels, elongate light assembly, PCB, LED or optical element. Beneficially, attributed to the different positions and sizes of the various parts of the lighting arrangements, a new lighting arrangement is obtained providing a different aesthetic lighting feature correspondingly. Generally, the type of lighting arrangement or the choice of optics being implemented in the lighting arrangement is dependent upon at least one aesthetic light feature, such as the light distribution required or the visual appearance including glare control, levels of surface reflection, colour and shape of lighting arrangement and parts therein and so forth to obtain a lighting arrangement having a required unique lighting configuration

Referring to FIG. 8, illustrated is a type of lighting arrangement 800 having an optical element 802, wherein the optical element 802 being a diffusing lens. As shown, the optical element 802 is a diffusing lens configured to diffuse or scatter generated light from the lighting arrangement 800 to transmit soft light therefrom. Examples of optical element 802 includes, but is not limited to, ground glass, Teflon, opal glass, and greyed glass. Specifically, the light is generated from an elongate light assembly 804, located laterally adjacent to the optical element 802, comprising a printed circuit board and one or more LED's arranged. Typically, the size and position of the elongate light assembly 804 may be varied with respect to the optical element 802, to beneficially obtain a different aesthetic lighting feature for the lighting arrangement 800 based on the relative positioning between the optical element 802 and the elongate light assembly 804.

FIG. 9 provides another type of lighting arrangement 900 with an optical element 902, wherein the optical element 902 being a forward linear lens. As shown, the optical element 902 is a forward linear lens configured to diffuse or scatter generated light from the lighting arrangement 900 to transmit soft light therefrom. Typically, as shown, the optical element 902 has a smaller size or thickness in comparison to the optical element 802. Examples of optical element 902 includes, but is not limited to, ground glass, Teflon, opal glass, and greyed glass. Specifically, the light is generated from an elongate light assembly 904, located laterally adjacent to the optical element 902, comprising a printed circuit board and one or more LED's. Typically, the size and position of the elongate light assembly 904 is varied, to beneficially obtain a different aesthetic feature for the lighting arrangement 900 based on the relative positioning between the optical element 902 and the elongate light assembly 904.

Referring to FIG. 10 illustrated is another type of lighting arrangement 1000 with clips 1002, 1004, forming a first channel 1006, are spaced apart from a second channel 1008. Typically, the first channel 1006 is configured to define the space for receiving horizontal legs of the T-bar 10 and the second channel 904 is configured to accommodate an elongate light assembly 1010 therein.

Referring to FIG. 11 illustrated is another type of lighting arrangement 1100 with a second channel 1104 defined at either side and beneath a first channel 1102 thereof. Typically, the first channel 1102 is configured to accommodate the T-bar 10 for support. Further shown, is an optical element 1106 having a triangular shape arranged in front on an elongate light assembly 1108. The optical element 1006 is utilized in order to provide a focused light configuration or the like, having a different aesthetic lighting feature in comparison to the other types of lighting arrangements 800, 900, 1000.

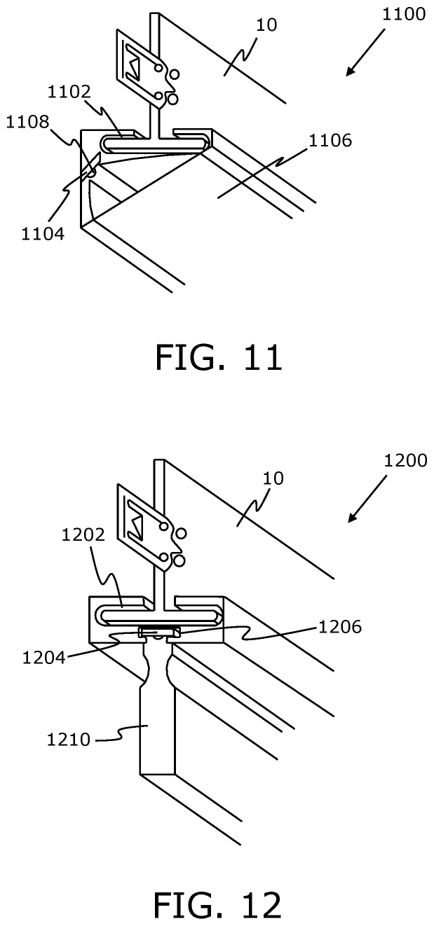

Referring to FIG. 12 illustrated is another type of lighting arrangement 1200 with the T-bar 10 being received by a first channel 1202 and an elongate light assembly 1204 is received by a second channel 1206. The lighting arrangement 1200 is also shown to include an optical element 1210 in the form of a light guide. The optical element 1210 is configured to distribute light from the source to a particular area. Generally, the light guides are made up of a transparent material (glass or plastic) and thin filaments capable of transmitting light signals via internal reflections.

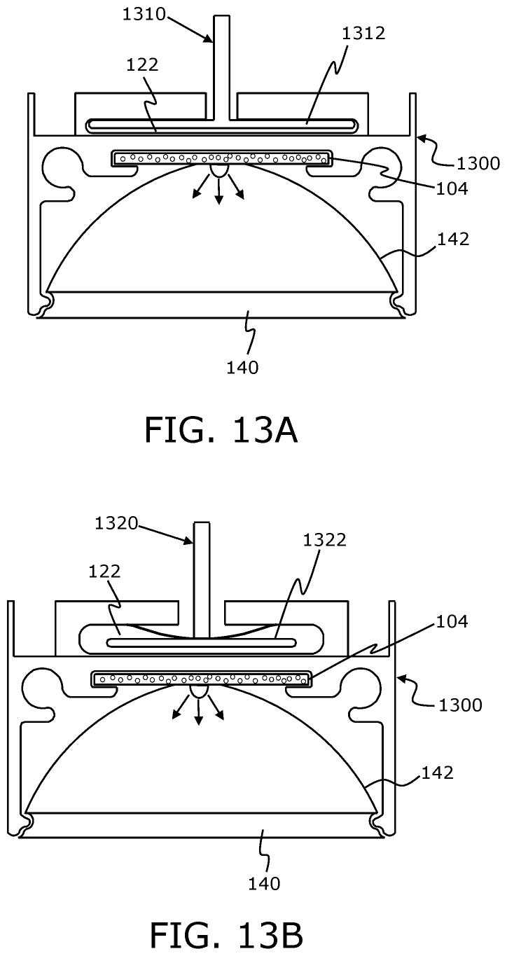

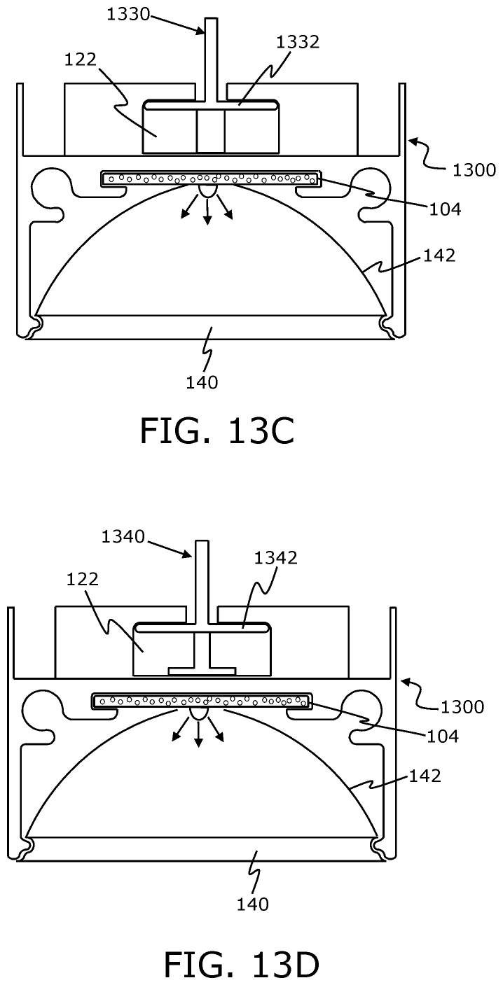

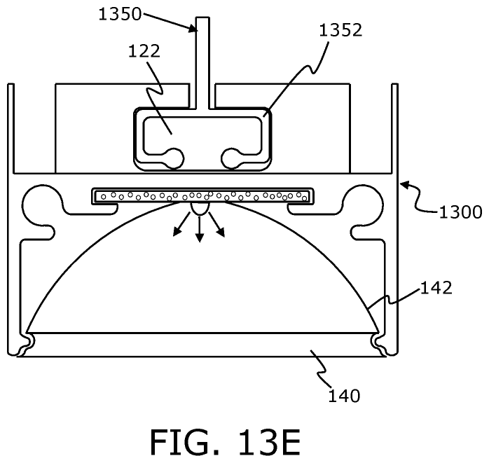

Referring to FIGS. 13A to E, illustrated are front views of a lighting arrangements 1300 with T-bars, in accordance with various embodiments of the present disclosure. Typically, the FIGS. 13A to E depicts various types of T-bars that can be suitably used in conjunction with the lighting arrangements 1300 of the present disclosure. It will be appreciated that the T-bars and the lighting arrangements 1300 illustrated in the FIGS. 13A to E are only exemplary and other different types may also be employed without limiting the scope of the disclosure. Typically, as illustrated in FIGS. 13A to E, the T-bars are being received by the first channel 122, having various configuration of the clip 1301 to accommodate different implementational requirements for the lighting arrangements 1300. The lighting arrangements 1300 includes an elongate light assembly, such as the elongate light 104, received the second channel 128 (shown in FIG. 4). Further, as illustrated in FIGS. 13A to E, the lighting arrangements 1300 include optical elements, such as the optical element 142 configured to reflect the incoming light to produce a desired light distribution after passing through the optical element 140. Typically, the optical element 142 is a reflector lens configured to collimate or redirect incoming light. Further, the optical element 140 works on the principle of diffusion to scatter beams of light as they travel through the optical element 140 based on the implementation.

Referring to FIG. 13A, illustrated is a front view of the lighting arrangement 1300 and T-bar 1310, in accordance with an embodiment of the present disclosure. As illustrated, horizontal legs 1312 of the T-bar 1310 conform to the first channel 122, configured by first and second clips (similar to the first clip 118 and the second clip 120 of FIG. 1). The lighting arrangement 1300 is used with the T-bar 1310 generally known as Prelude®.

Referring to FIG. 13B, illustrated is a front view of the lighting arrangement 1300 and T-bar 1320, in accordance with an embodiment of the present disclosure. As illustrated, horizontal legs 1322 of the T-bar 1320 conform to the first channel 122. The lighting arrangement 1300 is used with the T-bar 1320, generally known as Clear Room® and additionally comprises a holding clip 1323 which presses the lighting arrangement up and assure a tight seal between the lighting arrangement and a ceiling tile to minimize air leakage. This configuration is well suited for use in clean rooms.

Referring to FIG. 13C, illustrated is a front view of the lighting arrangement 1300 and T-bar 1330, in accordance with an embodiment of the present disclosure. As illustrated, horizontal legs 1332 of the T-bar 1330 conform to the first channel 122. Typically, the lighting arrangement 1300 is shown in used with the T-bar 1330, for example, generally known as Interlude®.

Referring to FIG. 13D, illustrated is a front view of the lighting arrangement 1300 and T-bar 1340, in accordance with an embodiment of the present disclosure. As illustrated, horizontal legs 1342 of the T-bar 1340 conform to the first channel 122. Typically, the lighting arrangement 1300 is shown in use with the T-bar 1340, for example, generally known as Sonata®.

Referring to FIG. 13E, illustrated is a front view of the lighting arrangement 1300 and T-bar 1350, in accordance with an embodiment of the present disclosure. As illustrated, horizontal legs 1352 of the T-bar 1350 conform to the first channel 122. Typically, the lighting arrangement 1300 is shown in used with the T-bar 1350, for example, generally known as Silhouette®.

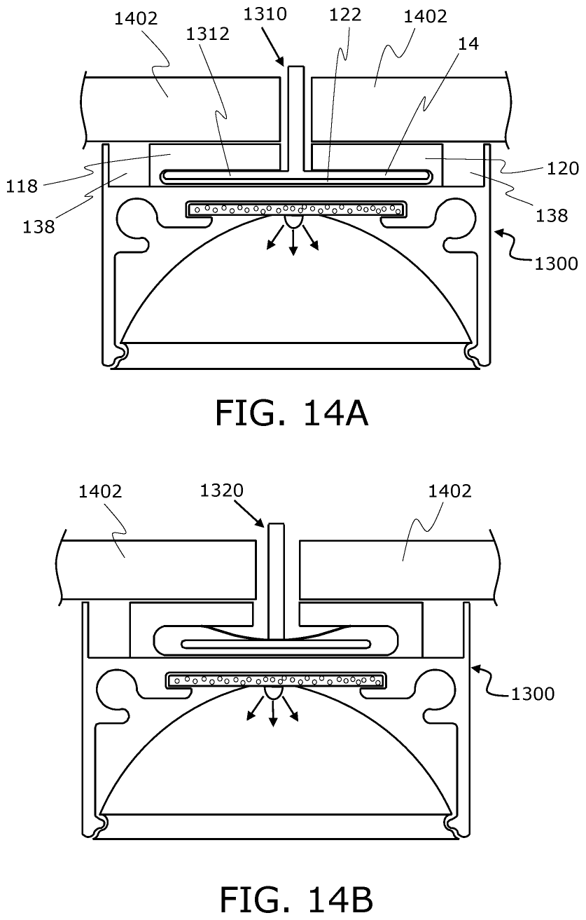

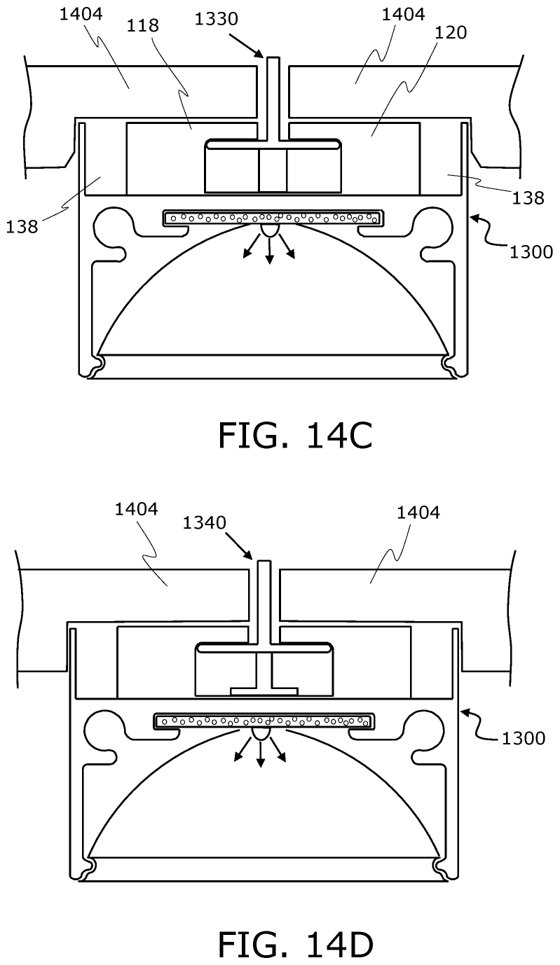

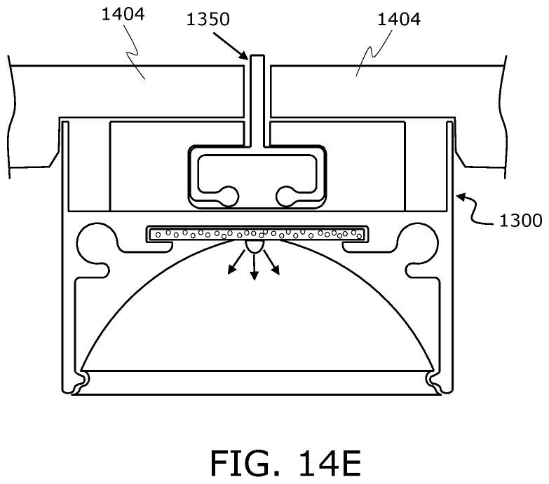

Referring now to FIGS. 14A-E, illustrated are front views of lighting arrangements in a utilized state, in accordance with various exemplary embodiment of the present disclosure. The FIGS. 14A-E, can be read in conjunction with the FIGS. 13A-E, depicting the lighting arrangements 1300 and T-bars 1310-1350 along with ceiling tiles.

As shown in FIGS. 14A-B, the ceiling tiles are shown supported on the T-bars 1310, 1320 with the lighting arrangements 1300. Specifically, as shown in FIG. 14A, ceiling tiles 1402 are shown supported on the T-bar 1310 with the lighting arrangement 1300 therebetween. For example, the ceiling tiles 1402 are supported on the first and second clips 118, 120, and over the one or more extrusions 138. Further, the first channel 122 (constituted by the first and second clips 118, 120) receives the horizontal legs 1312 of the T-bar 10. Similarly, the ceiling tiles 1402 are shown supported on the T-bar 1320 with the lighting arrangement 1300 therebetween, in the FIG. 14B.

As shown in FIGS. 14A-B, the ceiling tiles 1304 include a planar structure resting on the T-bars 1310, 1320 with the lighting arrangements 1200 therebetween. In other words, the ceiling tiles 1402 includes uniform thickness. However, the lighting arrangement 1300 of the present disclosure may be used in conjunction with ceiling tiles of other configuration, which is shown and explained in conjunction with FIGS. 14C-E.

Referring now to FIGS. 14C-E, the ceiling tiles 1404 are shown supported on the T-bars 1330-1350 with the lighting arrangements 1300. As shown in FIG. 14C, the ceiling tiles 1404 are non-planar structures, i.e. having non-uniform thickness, and being suitably supported on the T-bar 1330 with the lighting arrangement 1300 therebetween. As shown, the ceiling tiles 1404 include cut-section, conforming and resting on the first and second clips 118, 120, and over and around the one or more extrusions 138. This allows the lighting arrangement 1300 of the present disclosure to be suitably used in conjunction with T-bars and ceiling tiles of various configuration. For example, as shown in FIG. 14D-E, the ceiling tiles 1404 are shown supported on the T-bars 1340-1350 with the lighting arrangement 1300.

The lighting arrangement as described in the present disclosure provides a design to allow mounting thereof directly beneath a T-bar, wherein the lighting arrangement is arranged flush therewith to provide an appealing aesthetic appearance. The lighting arrangement also provide extrusions for routing of power supply lines and arrangement of LED drivers, etc. to provide an integrated product. The present lighting arrangement allows for mounting and interchanging of different (or even same) types of light assemblies directly beneath the same T-bar to provide unique lighting conditions. The lighting arrangement is easy to install, i.e. the lighting arrangement can simply slide into the T-bar, without a need for brackets, clips or additional suspension hardware. The present lighting arrangement is cost-effective to manufacture because of simple design of the extruded profile of the elongate body thereof, and further assembly of the lighting device therewith by simply sliding in a channel thereof. The present lighting arrangement is further simple to install as it could be slidably mounted or clipped onto the T-bar, thus saving on time and cost of installation.

The present disclosure provides an energy efficient and energy saving lighting arrangement configured for enabling a reduced greenhouse gas emission from the lighting arrangement by reducing the average energy consumption with respect to conventional lighting arrangements and reducing usage and implementation during times of minimal or no usage. Consequently, the lighting arrangement either needs to be remotely dimmable via a communication link (for example via the daisy-chain connection or via wireless control, or both) or needs to be controlled locally (for example by the lighting arrangement having a motion sensor integrated therewith, a low-resolution charged-coupled device (CCD) camera or a photocell coupled to an image processing integrated circuit (IC) implemented as a microcontroller, a field-programmable gate array (FPGA) for motion detection, alternatively an ultrasonic motion detector).

The lighting arrangement of the present disclosure eliminates a need and cost for brackets or other mounting or suspension hardware and does not require any cutting of ceiling tiles in the suspended ceiling grid arrangement. The lighting arrangement allows to provide for the length of the light fixture that matches the length of the T-bar, or it could be lesser or greater than the length as desired for aesthetic purposes. Furthermore, the present lighting arrangement provides for fixtures of shorter lengths that could be used together to provide a configurable overall length, and further can be used to combine fixtures such as spotlights and wall washers.

Modifications to embodiments of the present disclosure described in the foregoing are possible without departing from the scope of the present disclosure as defined by the accompanying claims. Expressions such as “including”, “comprising”, “incorporating”, have”, “is” used to describe and claim the present disclosure are intended to be construed in a non-exclusive manner, namely allowing for items, components or elements not explicitly described also to be present. Reference to the singular is also to be construed to relate to the plural.

We claim:

1. A lighting arrangement for use with a suspended ceiling system, the suspended ceiling comprising one or more T-bars with each of the one or more T-bars having a vertical leg and a horizontal leg, the lighting arrangement comprising when installed:
an elongate body comprising:
a base portion having a top plane and a bottom plane, and extending between a first end and a second end;
a first clip extending generally upwardly from the top plane at the first end of the base portion and a second clip extending generally upwardly from the top plane at the second end of the base portion, the first clip and the second clip, along with the base portion, defining a first channel therebetween; and
a first protrusion extending generally downwardly from the bottom plane at the first end of the base portion and a second protrusion extending generally downwardly from the bottom plane at the second end of the base portion, the first protrusion and the second protrusion, along with the base portion, defining a second channel therebetween; and
at least one elongate light assembly slidably received and disposed in the second channel of the elongate body,
wherein the elongate body is adapted to be supported directly beneath one of the T-bars by sliding along and receiving the horizontal leg of the given T-bar in the first channel thereof, to removably mount the lighting arrangement onto the given T-bar.

2. The lighting arrangement of claim 1, wherein the at least one elongate light assembly comprises:
a circuit board; and
one or more light emitting diodes (LEDs) arranged on the circuit board,
wherein the circuit board is slidably received and disposed in the second channel of the elongate body.

3. The lighting arrangement of claim 1, wherein the at least one elongate light assembly comprises a first elongate light assembly and a second elongate light assembly, and wherein the first elongate light assembly and the second elongate light assembly are of mutually different configurations.

4. The lighting arrangement of claim 3, wherein the elongate body has one or more extrusions formed therein, wherein the one or more extrusions have one or more power supply lines routed therethrough to connect electrically the first elongate light assembly and the second elongate light assembly in a daisy-chain manner.

5. The lighting arrangement of claim 1, wherein the elongate body is formed by extrusion molding of one or more of polypropylene, nylon, polyethylene and aluminum.

6. The lighting arrangement of claim 1, wherein the first clip and the second clip are of a rigid construction.

7. The lighting arrangement of claim 1, wherein the first clip and the second clip are of a semi-rigid construction, such that the first clip and the second clip are adapted to be flexed to, respectively, mount onto opposing ends of the horizontal leg of the given T-bar.

8. The lighting arrangement of claim 1, wherein the first clip and the second clip are formed of a substantially magnetic material, such that the first clip and the second clip are adapted to be, respectively, slidably received and thereafter firmly held with opposing ends of the horizontal leg of the given T-bar at desired position.

9. The lighting arrangement of claim 1 further comprising two walls extending downwardly from the first end and the second end of the base portion respectively, and have inwardly projecting lips to define a third channel therebetween.

10. The lighting arrangement of claim 9 further comprising at least one elongate optical element supported in the third channel such that the at least one elongate optical element is located directly beneath the at least one elongate light assembly.

11. The lighting arrangement of claim 1, further comprising an elongate optical element wherein the combined elongate body and elongate optical element is in the shape of a linearly extruded triangle and the elongate optical element is mounted non-parallel with respect to both the T-bar horizontal leg and T-bar vertical leg.

12. The lighting arrangement of claim 1, wherein the lighting arrangement further comprises a sensor arrangement configured to switch the lighting arrangement based on at least a user requirement or a user activity.

13. The lighting arrangement of claim 12, wherein the sensor arrangement further comprises at least one of a group consisting of; audio sensor, acoustic sensor, motion sensor, position sensor, proximity sensor, light sensor, ultrasonic sensor and accelerometer.

14. The lighting arrangement of claim 1, wherein the elongate light assembly further comprises a light guide.

15. The lighting arrangement of claim 14, wherein the light guide is oriented substantially parallel to the T-Bar horizontal leg.

16. The lighting arrangement of claim 14, wherein the light guide is oriented substantially parallel to the T-Bar vertical leg.
